(19) United States
(12) Patent Application Publication
(10) Pub. No.: US 2015/0019257 A1
(43) Pub. Date: Jan. 15, 2015

(54) SYSTEM AND METHOD FOR PREDICTIVE CARE MANAGEMENT

(71) Applicant: Covidien LP, Mansfield, MA (US)

(72) Inventors: Peter Doyle, Vista, CA (US); Gardner James Kimm, Carlsbad, CA (US); Mehdi M. Jafari, Laguna Hills, CA (US); Warren Sanborn, Escondido, CA (US); Sidney A. Jacobi, San Marcos, CA (US); Robert Hartman, San Marcos, CA (US)

(21) Appl. No.: 13/942,225

(22) Filed: Jul. 15, 2013

(51) Int. Cl. G06F 19/00

(52) U.S. Cl. CPC G06F 19/3431
USPC 705/3; 705/2

(57) ABSTRACT

Systems and methods for notifying clinicians of potential patient care risk scenarios and identifying remedial protocols to mitigate the risk. Patient data is downloaded from medical devices associated with the patient, such as, without limitation, a ventilator, bedside monitor, infusion pump, and/or dialysis machine. In addition physician medical orders and treatment notes are received. The patient data, medical orders, and treatment notes are analyzed by a state machine programmed to identify patient risk scenarios based upon known risk factors. Alerts and recommended courses of treatment are generated to enable caregivers to recognize high risk scenarios and to take preventative steps to reduce or avoid suboptimal outcomes. A plurality of state machines may be instantiated, enabling the system to monitor an arbitrary number of patients and treatment protocols.

### TECHNICAL FIELD

The present disclosure relates generally to patient monitoring systems and, in particular, to systems and methods for notifying clinicians of potential patient care risk scenarios and identifying remedial protocols to mitigate the risk.

### BACKGROUND

Today's healthcare industry is tasked with providing high quality healthcare at lower costs. While the medical knowledge base is growing rapidly, as are both the number and expense of diagnostic and therapeutic interventions, health care providers can no longer be expected to be familiar with the body of medical knowledge, nor to keep up with the continual changes in medical decision making that are intended to improve patient outcomes and reduce costs. Clinicians are often on-duty for long, continuous periods of time which increases the risk of errors in procedure or judgment, which may negatively affect patient outcomes.

The amount of data generated by a single patient can be overwhelming. For example, many devices are used to monitor patients. A ventilator may monitor a number of physiological parameters relating to patient care, such as respiratory rate, tidal volume, positive-end expiratory pressure (PEEP), and FIO₂. A pulse oximetry sensor may detect various patient blood flow characteristics, such as blood-oxygen saturation of hemoglobin in blood, amplitude of individual blood pulsations, and/or pulse rate of a patient. An infusion pump may indicate an infusion rate. Bedside monitors are able to monitor a patient's vital signs, including cardiac, hemodynamic, respiratory, neurological, and temperature parameters. A dialysis machine may indicate an ultrafiltration rate (UFR), a dialysate flow rate (DFR), a blood flow rate (BFR) and so forth. Devices such as these and others may include a communication interface to facilitate the remote monitoring of patient data and to receive configuration and/or operational data (such as ventilator settings) from a remote source.

Medical charts are used to keep track of all interactions with patients in a clinical environment. Every patient has a medical chart in which a wide variety of information is recorded by clinicians who interact with the patient. Since many people see multiple clinicians, it is not uncommon for patients to have multiple medical charts. Many hospitals employ an electronic medical records (EMR) system to supplement or supplant handwritten charts, ensuring that a patient's entire medical history can be readily accessed by clinicians with authority to input and/or review such records. Similarly, computerized physician order entry (CPOE) enables caregivers to enter instructions for the treatment of patients which may be communicated over a computer network to the medical staff or to the departments (pharmacy, laboratory, radiology, etc.) responsible for fulfilling the order.

### SUMMARY

In accordance with embodiments of the present disclosure, a computer-implemented method for monitoring a patient is presented. In embodiments, the disclosed method includes receiving a medical order defining a treatment protocol relating to a patient. At a processor, a rules engine, which may include a state machine, is instantiated and defines a risk scenario relating to the treatment protocol. One or more events relating to the treatment protocol are received by the state machine, and in accordance with the received event, the state machine transitions to a new state. If the new state corresponds to an increased patient risk, a notification is issued. Issuing a notification may include issuing a subsequent treatment protocol relating to the patient.

Issuing a notification may include modifying the treatment protocol relating to the patient. Receiving an event relating to the treatment protocol may include receiving a parametric event derived from a medical device associated with the patient. Receiving an event relating to the treatment protocol may include receiving a medical record entry associated with the patient. Receiving an event relating to the treatment protocol may include receiving a subsequent medical order associated with the patient. The subsequent medical order may define a subsequent treatment protocol relating to the patient.

The disclosed method may include determining if the differences between the subsequent medical order and prior medical order are reconcilable. The state machine is modified in accordance with the subsequent medical order if it is determined that the differences between the subsequent medical order and prior medical order are reconcilable. If it is determined that the differences between the subsequent medical order and prior medical order are irreconcilable, the state machine is terminated and a subsequent state machine is instantiated in accordance with the subsequent medical order.

In another aspect, the disclosed system and method is configured to identify patient care risk scenarios at various points of a treatment plan, and suggest alternative or modified treatment plans which seek to mitigate the identified risks. The responsible physician may then have an opportunity to review, accept, partially accept, modify, or decline the suggestions. Consider a set of orders which results in the following scenario for a given patient:

1) Complicated abdominal surgery.

2) Volume control ventilation in ICU.

3) Sedation, no patient breathing effort.

4) Extubation after 1½ days of ventilation.

5) Patient is sedated at time of extubation.

The disclosed system would generate a notification that, although ventilator acquired pneumonia (VAP) is normally not a risk factor for ventilations of such short duration, other risk factors have been identified that could predispose VAP. In embodiments, the notification articulates to the clinician the identified risk factors, and, additionally or alternatively, suggests a modified treatment plan to mitigate the identified risk. In other embodiments, the disclosed system may, within pre-established guidelines or permissions, autonomously take action to address the identified risk factor(s) without requiring clinician interaction. Continuing with the above example, the system may offer the following suggestions:

A) Daily sonogram of dorsal lower lung fields to detect onset of VAP.

B) Perform X-ray to confirm or rule out VAP.

C) Do not discharge patient before ruling out VAP.

Certain embodiments of the present disclosure may include some, all, or none of the above features. One or more other technical advantages may be readily apparent to those skilled in the art from the figures, descriptions, and claims included herein. Moreover, while specific advantages have been outlined above, various embodiments may include all, some, or none of the outlined advantages.

### BRIEF DESCRIPTION OF THE DRAWINGS

The present disclosure and its various aspects and features are described hereinbelow with reference to the accompanying drawings, wherein:

FIG. 1 is a block diagram of a care management protocol system in accordance with an embodiment of the present disclosure;

FIG. 2 is a block diagram of a protocol server in accordance with an embodiment of the present disclosure;

FIG. 3 is a process flow diagram of a care management protocol system in accordance with an embodiment of the present disclosure;

FIG. 4 is a state diagram on a protocol engine in accordance with an embodiment of the present disclosure; and

FIG. 5 is a flowchart illustrating a method of operating a care management protocol system in accordance with an embodiment of the present disclosure.

The Figures depict embodiments of the present disclosure for purposes of illustration only. One skilled in the art will readily recognize from the following description that alternative embodiments of the structures and methods illustrated herein may be employed without departing from the principles of the present disclosure described herein.

### DETAILED DESCRIPTION

Although patient care management appears predictable, in practice the situation is often unstable. A patient may presents with a suite of symptoms, which, when validated, leads to a course of treatment or care plan. However, there is always a risk that the original diagnosis was inadequate, new findings may be established, and/or new circumstances may arise which require that the treatment plan be altered.

In one aspect, disclosed is a care-management system and method that includes a protocol prediction and engine which takes advantage of known cause-and-effect situations that lead to adverse outcomes, such as lengthened care, higher costs, and risk/harm to the patient. As the system collects data relating to the patient, notifications are issued to the clinician and staff. The notifications advise that, at certain points of the patient care plan, a likelihood of an unintended risk event could occur, and that a particular intervention might detect and/or mitigate the risk.

By way of an example, aspects of the present disclosure will be presented with respect to a scenario in which a patient is received in the emergency room (ER), an examination is performed, tests are run, the diagnosis is confirmed, and the patient is sent to the operating room (OR) for surgery. The surgery is somewhat complicated but goes well, and the surgeon recommends two days in the intensive care unit (ICU) with breathing support provided by a mechanical ventilator to lessen the strain on the patient's respiratory system. In addition, because of the complexity of the surgery, a pain medication is prescribed, which means that the patient's breathing is wholly provided by the ventilator.

After about a day and one-half, the patient is taken off the ventilator. Although this process would appear simple, quite the opposite is true. The connection between patient and ventilator depends on a small-diameter, approximately ½ inch, plastic tube called an artificial airway, which connects to the ventilator's breathing circuit and extends into and through the mouth through the vocal cords into the trachea. A small inflated balloon (cuff) near the end of the airway seals the tube in the trachea. To remove the patient from the ventilator, the artificial airway must be extracted from the patient's trachea. Ideally, simply deflating the balloon cuff allows the artificial airway to be removed from the trachea. Assuming no adverse effects, the airway may then be quickly extracted, the patient is relieved of discomfort, and recovery ensues.

However, not every extubation procedure proceeds as planned. The artificial airway passes through the vocal cords at the junction of the orogastric system and the respiratory system. Any bacteria entering the lungs from the mouth or stomach has a high probability of seeding the lungs and initiating a bacterial infection. Such an infection can have significant consequences, and this particular sequela has been seen often enough (about 10% of the time) that it has been termed ventilator acquired pneumonia, or VAP. VAP can have serious patient-related consequences, and drives up the cost of care by about $50,000 to $100,000 per patient. Strict attention to ventilation management minimizes the incidence of VAP, but does not eliminate it.

This risk of contracting VAP increases markedly in patients who have been ventilated for at least three or more days; rarely would a patient ventilated for less than two days contract VAP unless another aggravating condition existed. For example, assume a patient was significantly sedated, the patient had gastric reflux, and the removal of the airway was not as efficient as normal because the patient could not cough or expectorate due to the sedation. Had gastric contents been aspirated during extubation, bacterial colonization of the lung would have been immediate and undetected. The patient, having seemingly undergone a normal extubation, would have been wheeled to the surgical ward for final recovery, and sent home. With no one focusing on an unintended outcome, the nursing team would not be expected be “on alert” for the unexpected outcome. Consequently, with each passing day the now-released patient would be suffering a bacterial infection, and eventually the patient would return to the hospital where the emergency room team would discover that the patient had a fully developed bacterial infection that would require rehospitalization.

The techniques of the present disclosure, which in at least one embodiment are employed to avoid the occurrence of a VAP, may be used in conjunction with any type of displayed medical data/information. For example, the medical data/information may be collected using a particular sensor or set of sensors, such as regional oxygen saturation sensors. By way of example, an INVOS® cerebral/somatic sensor, such as an OxyAlert™ NIR sensor by Somanetics or a SomaSensor® sensor by Somanetics, which may include one or more emitters and a pair of detectors for determining site-specific oxygen levels, may represent such sensors. In addition, when analyzing data via the INVOS® cerebral/somatic sensor, the present techniques allow a medical professional or user to highlight the area under the curve or plot for each channel of the INVOS® sensor. The present techniques may also be used in conjunction with other types of medical sensors, such as pulse oximetry sensors or carbon dioxide sensors. One skilled in the art may contemplate using a plurality of different sensors for measuring and/or monitoring a plurality of different physiologic parameters.

Reference will now be made in detail to embodiments of the present disclosure. While certain embodiments of the present disclosure will be described, it will be understood that it is not intended to limit the embodiments of the present disclosure to those described embodiments. To the contrary, reference to embodiments of the present disclosure is intended to cover alternatives, modifications, and equivalents as may be included within the spirit and scope of the embodiments of the present disclosure as defined by the appended claims.

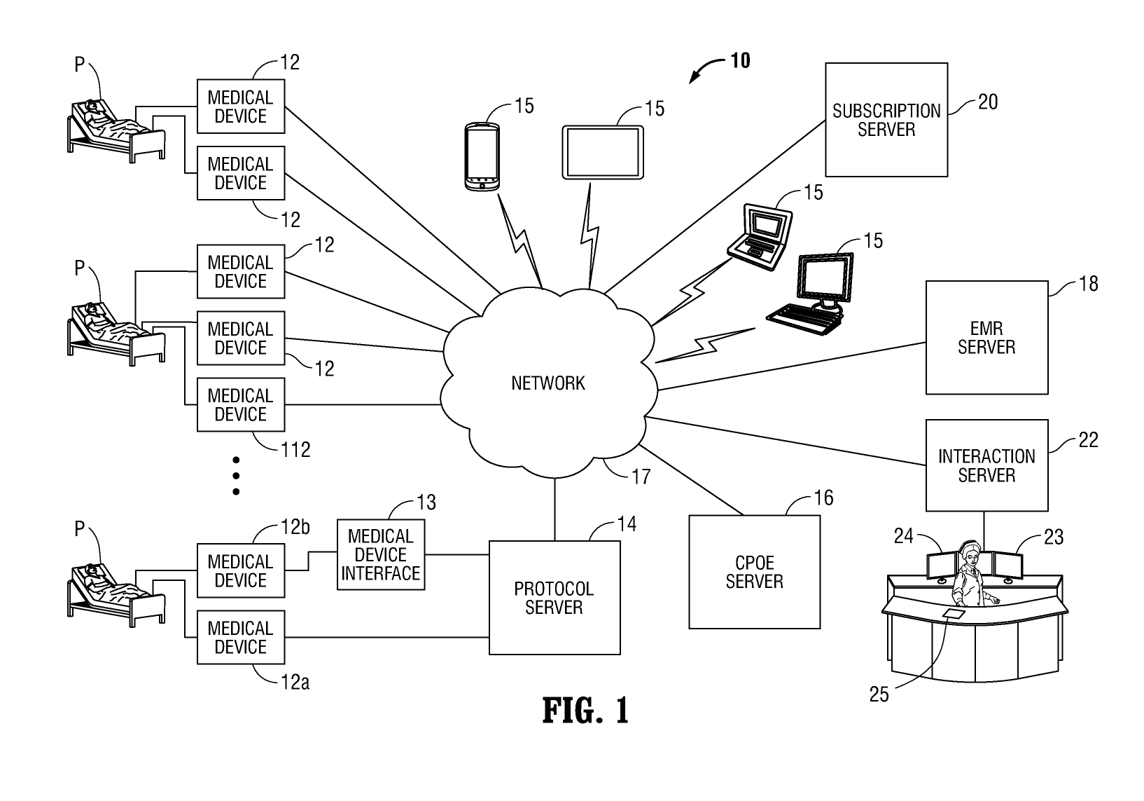

FIG. 1 illustrates a predictive care management system 10 in accordance with an example embodiment of the present disclosure. System 10 includes in operable communication a protocol server 14, a computerized physician order entry (CPOE) server 16, an electronic media records (EMR) server 18, a subscription server 20, an interaction server 22, one or more medical devices 12, and one or more remote devices 15. In the embodiment illustrated in FIG. 1, these elements are communicably linked by a data network 17, such as without limitation local area networks (LANs), radio access networks (RANs), metropolitan area networks (MANs), wide area networks (WANs), virtual private networks (VPNs), a portion of the global computer network known as the Internet, and/or any other communication system or systems at one or more locations, and may employ one or more signaling or communication protocols (TCP/IP) and/or transmission media (Ethernet, 802.11 WiFi, Token Ring, etc.) and may communicate, for example and without limitation, IP packets, Frame Relay frames, Asynchronous Transfer Mode (ATM) cells, voice, video, data, and other suitable information between network addresses.

In embodiments, protocol server 14, CPOE server 16, EMR server 18, subscription server 20, interaction server 22, medical devices 12 and/or remote devices 15 may operably communicate via any of network links, direct links, hardware links, software links, and virtual links. In embodiments, one or more of protocol server 14, CPOE server 16, EMR server 18, subscription server 20, and interaction server 22 may be configured as a virtual machine, or a software module executing in one or more processing units.

One or more remote devices 15, referred to primarily in the singular throughout this disclosure, may be any device that provides output to and may receive input from a user, such as a clinician. Each remote device 15 may include one or more computer systems at one or more locations. Each computer system may include any appropriate input devices (such as a keypad, touch screen, stylus, mouse, or other device that may accept input), output devices, mass storage media, or other suitable components for receiving, processing, storing, and communicating data. Both the input device and output device may include fixed or removable storage media such as a magnetic computer disk, CDROM, or other suitable media to both receive input from and provide output to a user. Each computer system may include a personal computer, workstation, network computer, smartphone, tablet computer, wearable computer, kiosk, wireless data port, personal data assistant, which may include one or more processors within these or other devices, or any other suitable processing device. In embodiments, a remote device 15 may be uniquely associated with a clinician, or may be uniquely associated with a group of clinicians. In embodiments, one or more remote devices may be associated with one patient and/or a group of patients. Thus, in embodiments, information relating to a particular patient P may be distributed, in whole or in part, among all remote devices whose user (e.g., the physician, nurse, therapist, etc.) shares responsibility for the care of patient P.

One or more medical devices 12, referred to primarily in the singular throughout this disclosure, may be any devices that are used for monitoring or treating a patient P. For example, medical device 12 may include a ventilator connected to a patient P to deliver respiratory therapy. As another example, medical device 12 may include a pulse oximeter that monitors the oxygen saturation of patient P's blood. As another example, medical device 12 may include a bedside monitor that senses vital signs of patient P. As another example, medical device 12 may include a device for tracking a patient without monitoring physiological conditions. In short, medical device 12 may include any suitable combination of software, firmware, and hardware used to support any medical function and/or operation. It should be noted that any suitable number of medical devices 12 may be included in system 10. In addition, there may be multiple groups of medical devices 12 in the system 10.

According to one embodiment of the present disclosure, in addition to performing a medical function and/or operation, medical device 12 may generate output data tracked by medical device 12. For example, the ventilator may generate entries indicating the average volume of air expelled in each breath. The ventilator may generate entries including the parameter settings used by the ventilator and an identification of whether any alarms have been triggered. The ventilator may store the generated entries in local memory and output the entries. In some embodiments, medical device 12 may generate output data that is related to the vital signs of a patient, including but not limited to heart rate, systolic and diastolic blood pressure, ECG, respiration rate, temperature, and so forth. In some embodiments, medical device 12 may generate output data that is related to tracking patient identifications or locations, without necessarily generating data related to a physiological condition. In certain embodiments, medical device 12 may output data in response to a data request (e.g., when polled). In certain other embodiments, medical device 12 may stream output data in an unsolicited, continuous, or regular manner.

Medical device 12 may be communicatively coupled to other components of system 10, e.g., protocol server 14, interaction server 22, etc., via network 17, which, according to some embodiments, facilitates wired and/or wireless communication. In embodiments, a medical device 12a may be communicatively coupled to other suitable devices, such as protocol server 14, via a direct link. In embodiments, a medical device 12b may be communicatively coupled via a medical device interface 13 that is configured to perform data translation, protocol translation, level matching, and/or other interfacing functions to facilitate interoperability of medical device 12b with system 10.

System 10 includes a CPOE server 16 that receives, stores, retrieves, and transmits medical orders of one or more clinicians relating to one or more patients. In embodiments, a clinician may enter an order using remote device 15 which communicates the order to CPOE server 16 via the communications links described above. A medical order may include, without limitation, intubation orders, ventilation orders, cardioversion orders, intravenous (IV) orders, monitoring orders, radiology orders, laboratory orders, comfort measures, pharmacy orders, therapy orders, psychiatric orders, ICD-9 and other medical codes, and so forth. EMR server 18 that receives, stores, retrieves, and transmits medical record entries (“chart entries”) written by one or more clinicians relating to one or more patients. In embodiments, a clinician may generate entries using remote device 15 which communicates the entry to EMR server 18 via the communications links described above. In embodiments, a clinician may generate entries utilizing a structured entry process which guides the clinician through the order entry process. In this manner, the risk of erroneous or inconsistent orders being entered into the system is reduced or eliminated.

System 10 includes one or more interaction servers 22 that are operatively associated with one or more interaction stations 23. In embodiments, and interaction station 23 may be situated at a nursing station and includes one or more displays 24 and/or one or more user interface devices 25 (e.g., keyboard, pointing device, touchscreen, voice input/output unit, etc.). In embodiments, information relating to one or more patients is aggregated from medical device 12, protocol server 14, CPOE server 16, and/or EMR server 18, and presented in whole or in part on display 24, enabling orders, alerts, alarms, and high-priority communications to be acted upon and/or acknowledged by the appropriate clinical staff.

Subscription server 20 is configured to provide data updates to components of system 10, e.g., protocol server 14, medical device 12, remote device 15, interaction server 22, CPOE server 16, and/or EMR server 20. Data updates may include software updates and/or firmware updates. In embodiments, subscription server 20 is configured to provide protocol updates (e.g., rules) to protocol server 14, as described in detail below. Protocol server 14, interaction server 22, CPOE server 16, and/or EMR server 20 may include one or more electronic computing devices operable to receive, transmit, process, and store data associated with system 10, for example and without limitation, one or more general-purpose Windows® PCs, Macintosh® computers, workstations, UNIX® system-based computers, server computers, one or more server pools, virtual machines, scalable processing resource pools, or any other suitable devices.

According to one embodiment, protocol server 14 is configured to receive patient monitoring data from medical devices 12 and medical orders data from CPOE server.

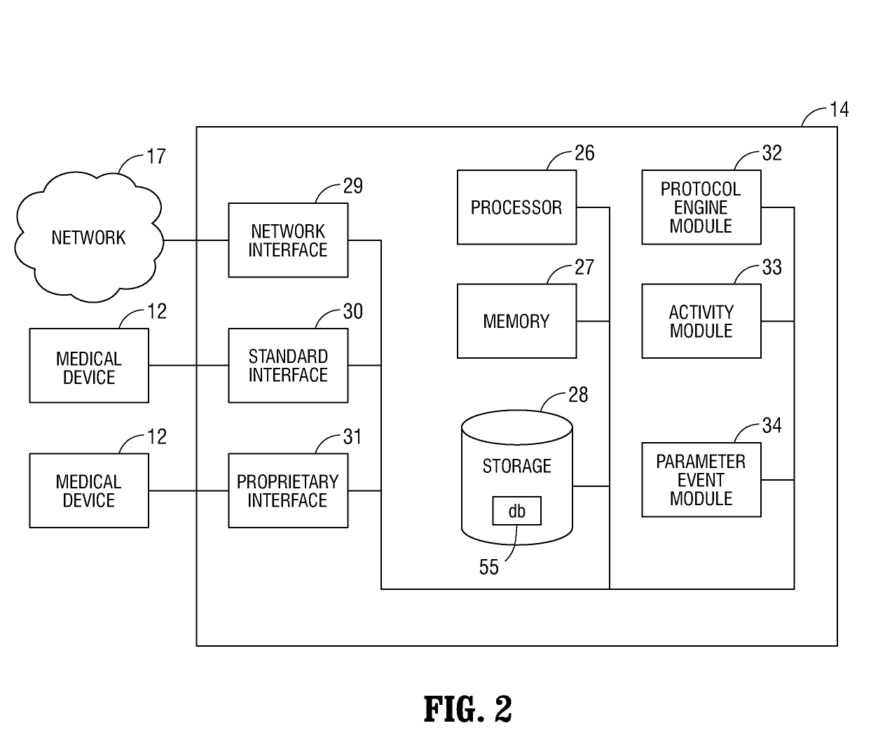

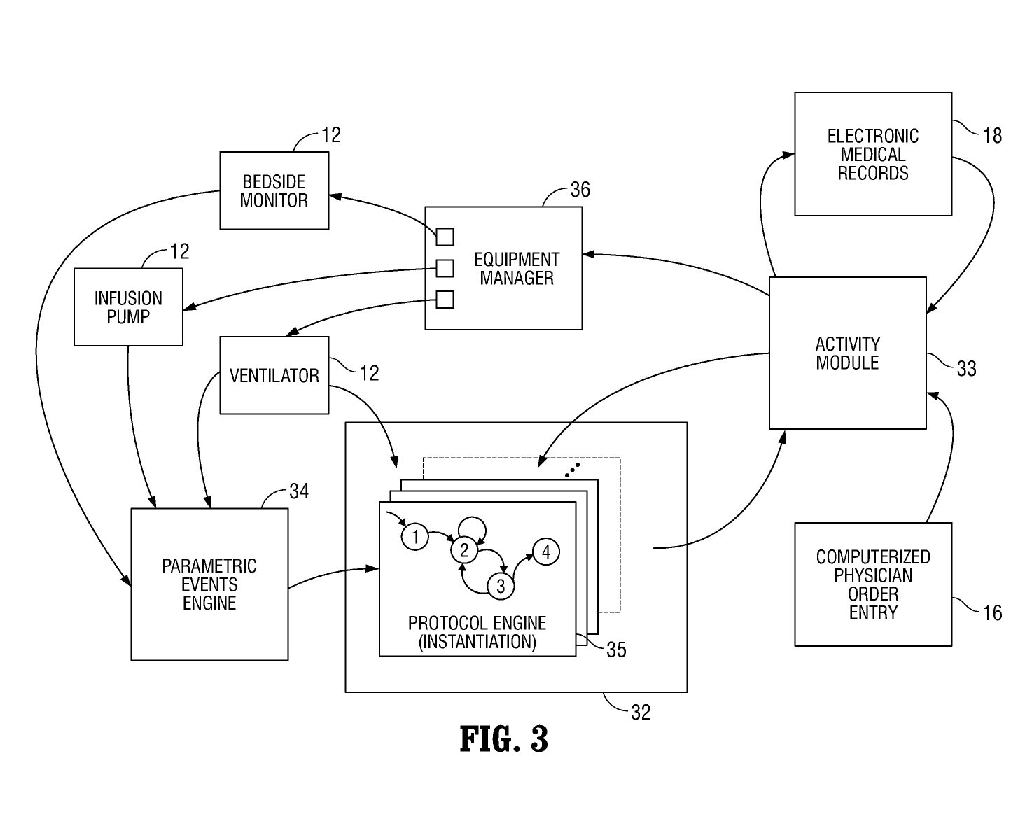

Turning now to FIGS. 2 and 3, system 10 includes protocol server 14 that is configured to receive patient monitoring data from the one or more medical devices 12, to receive medical orders from CPOE server 16 and/or remote devices 15, to transmit patient information (status, medical data, alerts, exceptions, and the like) to remote devices 15, EMR server 18, and/or interaction server 22.

As best seen in FIG. 2, protocol server 14 includes processor 26 in operable communication with memory 27 and storage unit 28. Memory 27 includes transitory memory, e.g., RAM or other suitable form of operational memory which stores executable software instructions, and data, as will be familiar to the skilled artisan. Storage unit 28 includes non-transitory memory, such as without limitation, a hard drive, non-volatile solid state memory (SSD, flash memory, etc.), optical drives (CD, DVD) and may include read/write and read-only media.

Protocol sever 14 include one or more network interface(s) 29 which may include a wired Ethernet interface (e.g., 10Base 1000 “Gigibit” interface), a wireless interface (e.g., 802.11n “WiFi”), a Bluetooth interface, and so forth. Network interface 29 facilitates communications between protocol server 14 and other networks nodes of system 10, e.g., medical devices 12 having network data transfer capabilities, CPOE server 16, other servers/network nodes as described herein, and other known devices (DNS servers, authentication servers, etc.) which may exist on a data network. In order to facilitate medical devices 12 which do not support network communication, e.g., legacy equipment, in embodiments protocol server 14 includes a standard interface 30, such as, without limitation, an RS-232 interface, RS-485, Centronics parallel port, and the like. In order to facilitate medical devices 12 which support a proprietary interface, in embodiments protocol server 14 includes a proprietary interface 31, which may include an expansion card (e.g., PCI card) which enables communication with the proprietary medical device 12. In embodiments, proprietary interface 31 includes hardware and software components (e.g., driver software).

Protocol server 14 includes, in operable communication among and between the aforesaid components of protocol server 14, a protocol engine module 32, an activity module 33, and a parametric event module 34. Protocol engine module 32 is in operable communication with protocol database 55 which stores a library of treatment protocols, which may be predetermined in accordance with standard medical practice for the particular care facility in which system 10 is operated. In embodiments, a treatment protocol may be revised, modified, or edited on a per-patient or other group basis in accordance with a medical order provided by an authorized clinician. In embodiments, protocol database 55 stores a library defining one or more cause-and-effect events that lead to adverse outcome events relating to a treatment protocol.

Activity module 33 is configured to process and store medical orders received from, e.g., CPOE server 16. In use, a clinician will enter a medical order relating to a patient P via a remote device 15, which, in turn, is communicated via network 17 to CPOE server 16. CPOE server 16, in turn, stores the medical order in association with patient P. Upon receipt of a new, modified, or deleted medical order, CPOE server 16 communicates the medical order to activity module 33 of protocol server 14.

Upon receipt of a medical order, activity module 33 determines whether the order includes a patient treatment protocol, e.g., one which corresponds to a treatment protocol stored in the library of treatment protocols of protocol database 55. Additionally or alternatively, activity module 33 is configured to ascertain whether the particular medical order has been instantiated for the target patient P by protocol engine module 32. In one aspect of the present disclosure, the instantiated order is a software object including a state machine that represents the elements of the specified protocol. In some embodiments, the instantiated order may be implemented as a rules engine, an inference engine, and/or a deterministic engine, and may employ forward-chaining rules (such as IF-THEN-ELSE logic and EVENT/REACTION logic). A complex rule or scenario may be expressed as a dedicated software module, or plug-in, which may be instantiated independently of, or included within, a state machine, rules engine, or other processing framework. In embodiments, the specified protocol includes a risk scenario that defines one or more patient states or conditions which, if met, indicate an increased risk of complication, infection, and/or undesirable outcome of a treatment protocol. If a protocol is not yet instantiated for patient P, activity module 33 causes protocol engine module 32 to instantiate an instance 35 of the specified protocol for the patient P. If a treatment protocol has already been instantiated, it may be modified in accordance with the new medical order if the differences are reconcilable (e.g., an insubstantial change which does not affect a fundamental aspect of the treatment protocol, such as a dosage change, a setpoint, a time interval, and the like). If the differences are irreconcilable, e.g., include contradictory, mutually exclusive, or fundamentally changed medical order, then the existing instantiation may be terminated and a new instance corresponding to the new medical order may be instantiated. In embodiments, protocol engine module 32 includes the capability to instantiate a plurality of concurrently executing instances 35, representing orders for a plurality of patients P.

Parametric event module 34 is configured to receive medical device data items transmitted from medical device(s) 12, identify the patient with whom the data item is associated, and convey the medical device data item to protocol engine module 32. In some embodiments, parametric event module 34 is configured to identify whether a particular medical device data item represents a monitored parameter, e.g., a parameter upon which a protocol event is conditioned, and/or whether the data item falls within (or outside of) a predetermined range, in accordance with a parametric event rule. In some embodiments, parametric event module 34 conveys only monitored parameters which have reached a trigger point, such as exceeding a certain threshold or falling within (or outside of) a predetermined range (e.g., systolic blood pressure exceeds 130 mmHg, heart rate falls below 30 BPM, etc.). In some embodiments, such parametric event rules are established when a protocol instance 35 is instantiated. In some embodiments, parametric event rules are included within protocol instance 35. In these embodiments, parametric event module 34 may not include parametric event rules (e.g., all or some parametric events are passed to the protocol instance 35). A parametric event rule may characterized as a simple event, e.g., based upon a single data item, or may a compound event, where two or more data items, orders, and so forth, occur concurrently or are otherwise related in time, delivery schedule, occurrence, etc.

In one aspect as depicted in FIG. 3, the disclosed system 10 includes an equipment manager 36 which is configured to receive configuration data from activity module 33, and convey the configuration data to the appropriate medical device 12. Configuration data may include, without limitation, setting data for a medical device (IV drip rate, ventilator parameters, airway diameter, etc.). Equipment manager 36 may be configured as a software module, a hardware module, or a combination software/hardware module in accordance with the requirements of the particular medical devices in use, e.g., communication protocols, transmission media, authentication requirements and the like.

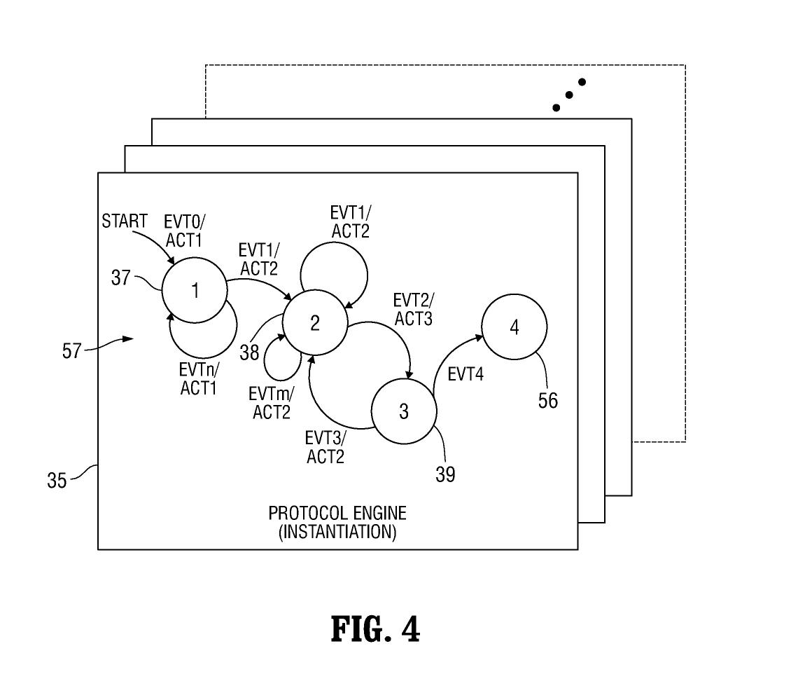

Turning now to FIG. 4, example states of an example protocol instantiation 35 are now described. Note that inputs to the state machine 57 embodied in protocol instantiation 35 may be patient data items received from parametric events engine 34, physician orders, or electronic records received from CPOE server 16 and EMR server 18, respectively, via activity module 33 as described above. Instantiation 35 comes into existence upon an initial event, such as admission, surgery, or issuance of a medical order, as transmitted to protocol engine 32 by activity module 33 and/or parametric events engine 34, as described elsewhere herein.

State machine 57 receives an initial input event EVT0 representing the fact that the patient has undergone a procedure, for example a complicated abdominal surgery, which transitions state machine 57 to state 1, designated by reference number 37. Various other patient data items and medical orders may be received by state machine 57, e.g., events EVTn, which may be immaterial to the current instantiation. These events may be effectively ignored by transitioning the state machine to the current state 1 in that no change of state occurs as a result of receiving these non-material events. At some point, a medical order is received indicating the patient is to be transferred to the ICU for volume control ventilation. This event representing transition event EVT1 is recognized, and transitions the state machine to state 2 (reference number 38). Again, inputs may be received by state machine 57, e.g., events EVTm, EVT1, which transitions or maintains the state machine at current state 2.

At this point, a pharmaceutical order indication the patient is to be sedated is received, and in addition, a patient data item is received from a ventilator medical device 12 which indicated no breathing effort is being exerted by the patient (e.g., full breathing pressure is supplied by the ventilator pump. The compound event is identified as EVT2, which transitions the state machine to state 3 (reference number 39). Subsequently, a compound event EVT4 is received wherein it is indicated that extubation was performed while the patient was still sedated, and unaware of extubation, which transitions state machine 57 to state 4 (indicated by reference number 56). State 4 is reactive event, which, when state 4 is entered, state machine 57 generates an output. In this example, the output may include generation of a system-generated medical order wherein a daily sonogram of the dorsal lower lung fields of patient P is performed to detect onset of VAP, a suspected incidence of VAP must be confirmed with a chest X-ray, and that patient P may not be discharged without affirmatively ruling out the presence of VAP. The generated order may be accepted automatically, or may be presented to an authorized clinician for approval, modification, or disapproval. In embodiment, the generated order may include revised operational parameters for the one or more medical devices associated with patient P. In embodiments, the revised operational parameters may be automatically transmitted and applied (e.g., made operational) to the medical device. In some embodiments, the revised operational parameters may be automatically transmitted to the medical device, but only be applied upon affirmative confirmation by a clinician at the medical device control panel, or, additionally or alternatively, via a remote control interface. In embodiments instantiation 35 may terminate, or may continue to execute to monitor patient P as appropriate. In embodiments, entry of a medical order may cause a new instantiation to supersede a currently-executing instantiation, or may cause execution of a currently-executing instantiation to terminate (e.g., when a patient is discharged or expires).

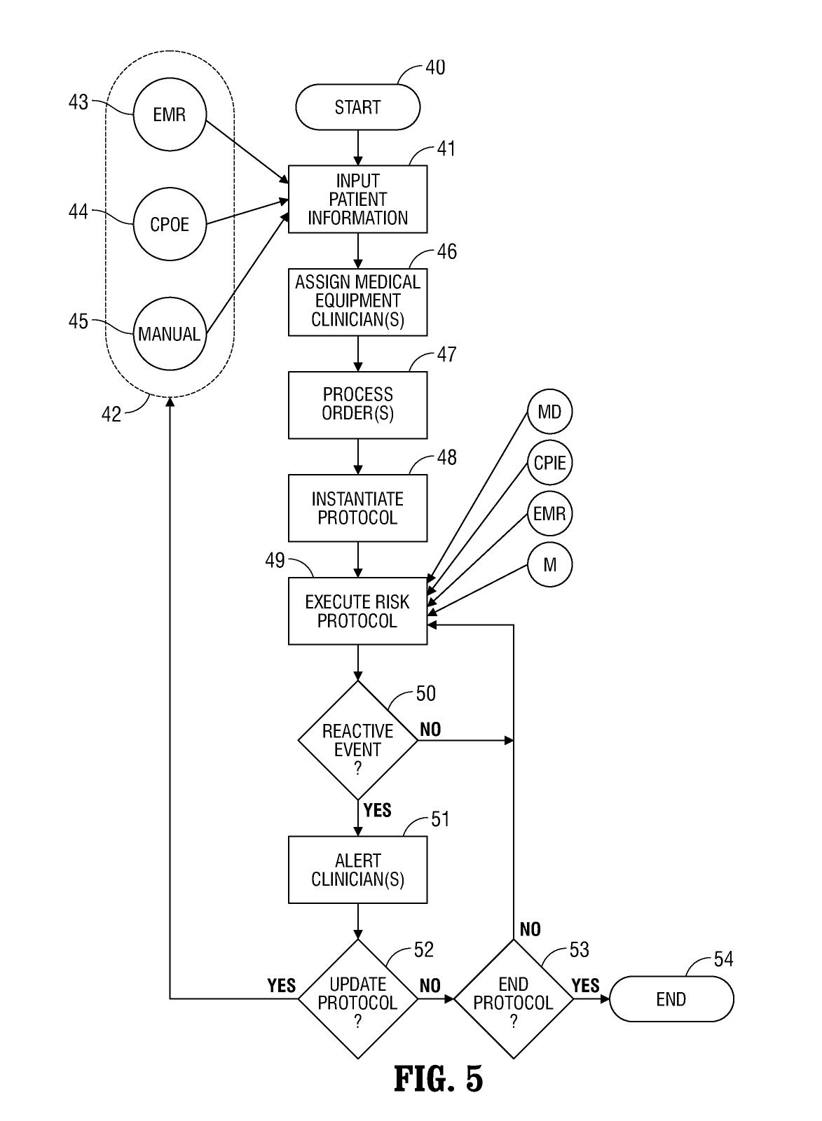

Turning now to FIG. 5, a method of operating a computer-implemented predictive protocol care management system is shown. The method begins with the step 40 wherein initialization, memory allocation, and housekeeping functions are performed. In the step 41, initial patient information about subject patient P is input to the system. In embodiments, patient information is input from a patient information source 42, and may include the step 43 of inputting patient information from an electronic medical records computer, the step 44 of inputting patient information from a computerize physician order entry system 44, and/or the step 45 of manually inputting patient information, e.g., from a remote device 15 and/or interaction server 22.

In the step 46, one or more pieces of medical equipment, e.g., medical devices, are assigned to P. Each medical device includes a unique identifier, which is represented or otherwise encoded in the data transmitted by the device to identify the source of the data. For example, the treatment protocol may require that patient P be hooked up to a medical devices including a bedside monitor and a ventilator. The identifiers of the specific machines in use with patient P are associated in step 46 with patient P, to distinguish patient P's data from that collected on behalf of other patients in the facility. This association may be automatic using, for example, an IP address of the medical device (static or dynamic), a hostname or other label assigned to the medical device, or a manual ID entered by a clinician to associate the machine with the patient P. Advantageously, this enables the disclosed system and method to successfully function with multiple and/or networked devices in use by a plurality of patients in a treatment facility. In embodiments, one or more clinicians are assigned to patient P, which may include without limitation a supervising physician, an attending physician, an attending nurse, a therapist, and so forth.

In the step 47, one or more medical orders are processed to determine a risk scenario that defines one or more patient states or conditions which, if met, indicate an increased risk of complication, infection, and/or undesirable outcome of a specified protocol, and in the step 48 instantiates a state machine representing the progression of medical states leading to an increased risk scenario. In the step 49, the instantiated protocol is executed, and begins to receive events from the medical devices 12, the computerized physician order entry computer 16, the electronic medical records computer 18, and/or a manual entry from, e.g., a remote device 15. As events are received, they are evaluated in view of the risk protocol. Upon identification in step 50 of a reactive event, e.g., an event which triggers a risk scenario, in the step 51 an alert is generated to inform a clinician (which may be a physician assigned in step 46 above) of the risk situation and to give the clinician an opportunity to response to the alert.

In the step 52, a determination is made whether the existing treatment protocol and/or risk profile is to be updated or revised in response to the alert. If the protocol is to be updated, the new and/or revised protocol, patient data, etc. is entered in the step 41. If no revisions are indicated, in the step 53 a determination is made as to whether the currently-executing protocol is to continue, or terminate. If the protocol is to continue, processing iterates to the step 49 wherein the instantiated protocol resumes execution, otherwise, the process concludes in the step 54.

Particular embodiments of the present disclosure have been described with reference to the accompanying drawings; however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions.

Additionally, the present disclosure may be described in terms of functional block components, code listings, optional selections, page displays, and various processing steps. It should be appreciated that such functional blocks may be realized by any number of hardware and/or software components configured to perform the specified functions. For example, embodiments of the present disclosure may employ various integrated circuit components, e.g., memory elements, processing elements, logic elements, look-up tables, and the like, which may carry out a variety of functions under the control of one or more microprocessors or other control devices.

Similarly, the software elements of embodiments of the present disclosure may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed on a variety of operating systems including, without limitation, Windows®, Macintosh OSX®, iOS®, linux, and/or Android®.

Further, it should be noted that embodiments of the present disclosure may employ any number of conventional techniques for data transmission, signaling, data processing, network control, and the like. It should be appreciated that the particular embodiments shown and described herein are illustrative of the disclosure and its best mode, and are not intended to otherwise limit the scope of the present disclosure in any way. Examples presented herein which include sample data items (e.g., names, dates, etc.) are intended as examples and are not to be construed as limiting. Indeed, for the sake of brevity, conventional data networking, application development and other functional aspects of the systems (and components of the individual operating components of the systems) may not be described in detail herein. Furthermore, the connecting lines shown in the various figures contained herein are intended to represent example functional relationships and/or physical or virtual couplings between the various elements. It should be noted that many alternative or additional functional relationships or physical or virtual connections may be present in a practical electronic data communications system.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., USB thumb drives) and/or the like.

Embodiments of the present disclosure are described with reference to block diagrams and flowchart illustrations of methods, apparatus (e.g., systems), and computer program products according to various aspects of the disclosure. It will be understood that each functional block of the block diagrams and the flowchart illustrations, and combinations of functional blocks in the block diagrams and flowchart illustrations, respectively, may be implemented by computer program instructions. These computer program instructions may be loaded onto a general purpose computer, special purpose computer, mobile device or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems that perform the specified functions or steps, or suitable combinations of special purpose hardware and computer instructions.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like.

References made to the example embodiments illustrated in the drawings, and specific language describing the same, is for the purposes of promoting an understanding of the principles of the present disclosure. It should be understood that no element is essential to the practice of the disclosure unless specifically described herein as “critical” or “essential.” Moreover, the steps recited in any method claims may be executed in any order and are not limited to the order presented in the claims.

While several embodiments of the disclosure have been shown in the drawings and described in detail hereinabove, it is not intended that the disclosure be limited thereto, as it is intended that the disclosure be as broad in scope as the art will allow. Therefore, the above description and appended drawings should not be construed as limiting, but merely as exemplifications of particular embodiments. Those skilled in the art will envision other modifications within the scope and spirit of the claims appended hereto.

What is claimed is:

1. A computer-implemented method for monitoring a patient, comprising the steps of:
receiving a medical order defining a treatment protocol relating to a patient;
instantiating, at a processor, a state machine defining a risk scenario relating to the treatment protocol;
receiving, by the state machine, an event relating to the treatment protocol;
transitioning the state machine to a new state in accordance with the received event; and
issuing a notification if the new state corresponds to an increased patient risk.

2. The computer-implemented method in accordance with claim 1, wherein issuing a notification includes issuing a subsequent treatment protocol relating to the patient.

3. The computer-implemented method in accordance with claim 1, wherein issuing a notification includes modifying the treatment protocol relating to the patient.

4. The computer-implemented method in accordance with claim 1, wherein receiving an event relating to the treatment protocol includes receiving a parametric event derived from a medical device associated with the patient.

5. The computer-implemented method in accordance with claim 1, wherein receiving an event relating to the treatment protocol includes receiving a medical record entry associated with the patient.

6. The computer-implemented method in accordance with claim 1, wherein receiving an event relating to the treatment protocol includes receiving a subsequent medical order associated with the patient.

7. The computer-implemented method in accordance with claim 6, wherein the subsequent medical order defines a subsequent treatment protocol relating to the patient.

8. The computer-implemented method in accordance with claim 7, further comprising the steps of:
determining if the differences between the subsequent medical order and prior medical order are reconcilable;
modifying the state machine in accordance with the subsequent medical order if it is determined that the differences between the subsequent medical order and prior medical order are reconcilable; and
terminating the state machine and instantiating a subsequent state machine in accordance with the subsequent medical order if it is determined that the differences between the subsequent medical order and prior medical order are irreconcilable.

9. Non-transitory computer-readable media comprising software which, when executed by a computer system, causes the computer system to perform operations comprising:
receiving a medical order defining a treatment protocol relating to a patient;
instantiating a state machine defining a risk scenario relating to the treatment protocol;
receiving, by the state machine, an event relating to the treatment protocol;
transitioning the state machine to a new state in accordance with the received event; and
issuing a notification if the new state corresponds to an increased patient risk.

10. The non-transitory computer-readable media in accordance with claim 9, wherein issuing a notification includes issuing a subsequent treatment protocol relating to the patient.

11. The non-transitory computer-readable media in accordance with claim 9, wherein issuing a notification includes modifying the treatment protocol relating to the patient.

12. The non-transitory computer-readable media in accordance with claim 9, wherein receiving an event relating to the treatment protocol includes receiving a parametric event derived from a medical device associated with the patient.

13. The non-transitory computer-readable media in accordance with claim 9, wherein receiving an event relating to the treatment protocol includes receiving a medical record entry associated with the patient.

14. The non-transitory computer-readable media in accordance with claim 9, wherein receiving an event relating to the treatment protocol includes receiving a subsequent medical order associated with the patient.

15. The non-transitory computer-readable media in accordance with claim 14, wherein the subsequent medical order defines a subsequent treatment protocol relating to the patient.

16. The non-transitory computer-readable media in accordance with claim 15, further comprising the steps of:
determining if the differences between the subsequent medical order and prior medical order are reconcilable;
modifying the state machine in accordance with the subsequent medical order if it is determined that the differences between the subsequent medical order and prior medical order are reconcilable; and
terminating the state machine and instantiating a subsequent state machine in accordance with the subsequent medical order if it is determined that the differences between the subsequent medical order and prior medical order are irreconcilable.

17. A system for predictive care management of a clinical patient physiologically associated with a medical device, comprising:
a processor,
a database in operative communication with the processor and storing a library of treatment protocols;
an activity module configured for operative communication with a device selected from a computerized physician order entry computer and an electronic medical record computer;
a parametric event module configured for operative communication with the medical device; and
a protocol engine module in operative communication with the database, the activity module, and the parametric event module, and configured to instantiate a treatment protocol in accordance with a physician order and evaluate a physiological parameter received from the medical device to identify a potential risk factor of the treatment protocol.

18. The system in accordance with claim 17, wherein the parametric event module inhibits receipt of the medical device event by the protocol engine module if the physiological parameter has a value which falls outside a predetermined range.

19. The system in accordance with claim 17, wherein the medical device is selected from the group consisting of a ventilator, a bedside monitor, a pulse oximetry sensor, in infusion pump, and a dialysis machine.

20. The system in accordance with claim 17, further comprising a remote device in operative communication with at least one of the protocol engine module, the computerized physician order entry computer and the electronic medical record computer.
